(19) United States
(12) Patent Application Publication
(10) Pub. No.: US 2023/0009814 A1
(43) Pub. Date: Jan. 12, 2023

(54) METHOD FOR TRAINING INFORMATION RECOMMENDATION MODEL AND RELATED APPARATUS

(71) Applicant: Tencent Technology (Shenzhen) Company Limited, Shenzhen (CN)

(72) Inventors: Xiaobo HAO, Shenzhen (CN); Kaikai GE, Shenzhen (CN); Yudan LIU, Shenzhen (CN); Linyao TANG, Shenzhen (CN); Ruobing XIE, Shenzhen (CN); Xu ZHANG, Shenzhen (CN); Leyu LIN, Shenzhen (CN)

(21) Appl. No.: 17/948,079

(22) Filed: Sep. 19, 2022

Related U.S. Application Data
(63) Continuation of application No. PCT/CN2021/101522, filed on Jun. 22, 2021.

(30) Foreign Application Priority Data
Aug. 28, 2020 (CN) 202010887619.4

(51) Int. Cl. G06Q 30/06; G06Q 30/02

(52) U.S. Cl. CPC G06Q 30/0631; G06Q 30/0201; G06Q 30/0202

(57) ABSTRACT

Embodiments of this application provide a for training an information recommendation model. The method includes: obtaining historical user behavior data in a plurality of product domains; generating candidate sample data of one or more target product domains according to the historical user behavior data by using a generative model; performing user-specific authenticity sample discrimination on candidate sample data of the target product domains and actual user click sample data by using a discriminative model, to obtain a discrimination result; and performing adversarial training on the generative model and the discriminative model according to the discrimination result, to obtain a trained generative adversarial network as an information recommendation model for a to-be-expanded product domain in the plurality of product domains. According to the method, the training effect of the generative model may be improved, the accuracy of generating the pseudo sample is improved, thereby further improving the recommendation effect.

### CROSS-REFERENCE TO RELATED APPLICATIONS

This application is a continuation application of PCT Patent Application No. PCT/CN2021/101522, entitled “INFORMATION RECOMMENDATION MODEL TRAINING METHOD AND RELATED DEVICE” filed on Jun. 22, 2021, which claims priority to Chinese Patent Application No. 202010887619.4, filed with the State Intellectual Property Office of the People's Republic of China on Aug. 28, 2020, and entitled “METHOD FOR TRAINING INFORMATION RECOMMENDATION MODEL AND RELATED APPARATUS”, all of which are incorporated herein by reference in their entirety.

### FIELD OF THE TECHNOLOGY

This application relates to the field of computers, and in particular, to information recommendation.

### BACKGROUND OF THE DISCLOSURE

With the development of the Internet and rapid growth of information, how to effectively screen and filter information and accurately recommend information such as movies, commodities, or food that users are interested in to the user is an important research topic.

Existing recommendation methods are usually performed based on a specific product or application (APP), and users are often target users of the product or the APP. As a result, the user circle is limited. In addition, even in consideration of implementing the recommendation method based on a plurality of products or APPs, training a multi-target model by using different quantities of user behavior logs together cannot effectively perform model training due to a great difference between quantities of user behavior logs of different products.

### SUMMARY

To resolve the foregoing technical problems, this application provides an artificial intelligence-based method for training an information recommendation model, to achieve cross-product domain recommendation with higher prediction accuracy, so that a generated pseudo sample has a better effect, thereby further improving the recommendation effect during information recommendation.

The following technical solutions are disclosed in embodiments of this application:

According to an aspect, an embodiment of this application provides a method for training an information recommendation model, the method including:

obtaining historical user behavior data in a plurality of product domains;

generating, according to the historical user behavior data, candidate sample data of one or more target product domains including a to-be-expanded product domain in the plurality of product domains by using a generative model in a generative adversarial network;

performing user-specific authenticity sample discrimination on candidate sample data of the target product domains and acquired user click sample data by using a discriminative model in the generative adversarial network, to obtain a discrimination result; and

performing adversarial training on the generative model and the discriminative model according to the discrimination result, to obtain a trained generative adversarial network, the generative adversarial network being configured to determine an information recommendation model for the to-be-expanded product domain.

According to another aspect, an embodiment of this application provides an apparatus for training an information recommendation model, the apparatus including an obtaining unit, a generation unit, a discriminative unit, and a training unit, where

the obtaining unit is configured to obtain historical user behavior data in a plurality of product domains;

the generation unit is configured to generate, according to the historical user behavior data, candidate sample data of a to-be-expanded product domain in the plurality of product domains by using a generative model in a generative adversarial network;

the discriminative unit is configured to use each product domain in the plurality of product domains as a target product domain, and perform user-specific authenticity sample discrimination on candidate sample data of the target product domain and acquired user click sample data by using a discriminative model in the generative adversarial network, to obtain a discrimination result; and

the training unit is configured to perform adversarial training on the generative model and the discriminative model according to the discrimination result, to obtain a trained generative adversarial network, the trained generative adversarial network being configured to determine an information recommendation model.

According to another aspect, an embodiment of this application provides a device for training an information recommendation model, including a processor and a memory, where

the memory is configured to store program code and transmit the program code to the processor; and

the processor is configured to perform the foregoing method for training an information recommendation model according to instructions in the program code.

According to another aspect, an embodiment of this application provides a non-transitory computer-readable storage medium, configured to store program code, the program code being used to perform the foregoing method for training an information recommendation model.

According to yet another aspect, an embodiment of this application provides a computer program product including instructions, the computer program product, when run on a computer, causing the computer to perform the foregoing method for training an information recommendation model.

It can be seen from the foregoing technical solutions that, during training, historical user behavior data in a plurality of product domains may be obtained. Since a user is less likely to simultaneously use a plurality of products, and consequently, user behavior features in a multi-product domain are sparse, the amount of user behavior data in the plurality of product domains is insufficient, and especially for a product domain with less user behavior data, it is difficult to train and obtain an effective information recommendation model. Therefore, candidate sample data of a to-be-expanded product domain in the plurality of product domains is generated according to the historical user behavior data by using a generative model in a generative adversarial network, to generate a pseudo sample to increase the amount of the user behavior data. Each product domain in the plurality of product domains is used as a target product domain, user-specific authenticity sample discrimination is performed on candidate sample data of the target product domain and acquired user click sample data by using a discriminative model in the generative adversarial network to obtain a discrimination result, and adversarial training is further performed on the generative model and the discriminative model according to the discrimination result, to obtain a trained generative adversarial network. The trained generative adversarial network may be configured to determine an information recommendation model. According to the method, the generative adversarial network is introduced into cross-product domain information recommendation, and adversarial training is performed on the discriminative model and the generative model in the generative adversarial network according to user behavior data in the plurality of product domains. A fairly good output is generated through mutual game learning between the discriminative model and the generative model, so that the generative model has higher prediction accuracy, and a generated pseudo sample has a better effect, thereby further improving the recommendation effect during information recommendation.

### BRIEF DESCRIPTION OF THE DRAWINGS

To describe the technical solutions in the embodiments of this application or the existing technologies more clearly, the following briefly describes the accompanying drawings required for describing the embodiments or the existing technologies. Apparently, the accompanying drawings in the following description show only some embodiments of this application, and a person of ordinary skill in the art may derive other drawings from the accompanying drawings without creative efforts.

FIG. 1 is a schematic diagram of an application scenario of a method for training an information recommendation model according to an embodiment of this application.

FIG. 2 is a flowchart of a method for training an information recommendation model according to an embodiment of this application.

FIG. 3 is an overall framework diagram of an information recommendation method according to an embodiment of this application.

FIG. 4A is a schematic model structural diagram of a generative model in an AFT model according to an embodiment of this application.

FIG. 4B is a schematic model structural diagram of a discriminative model in an AFT model according to an embodiment of this application.

FIG. 5 is a schematic structural diagram of a combined model of an AFT model according to an embodiment of this application.

FIG. 6A is a schematic diagram of a recommendation interface “Top Stories” of an APP according to an embodiment of this application.

FIG. 6B is a schematic diagram of a recommendation interface of a reading APP according to an embodiment of this application.

FIG. 7 is a flowchart of a cross-domain information recommendation method according to an embodiment of this application.

FIG. 8 is a structural diagram of an apparatus for training an information recommendation model according to an embodiment of this application.

FIG. 9 is a structural diagram of a terminal device according to an embodiment of this application.

FIG. 10 is a structural diagram of a server according to an embodiment of this application.

### DESCRIPTION OF EMBODIMENTS

Embodiments of this application are described below with reference to the accompanying drawings.

In an interest recommendation system, a conventional recommendation method is performed based on a specific product or APP, and users are often target users of the product. As a result, the user circle is limited.

For example, in a specific APP, a user often only expresses points of interest related to content of the APP. For example, in a video APP, the user likes to watch video content such as variety shows or TV plays, but in a reading APP, the user may be interested in books rather than the variety shows or TV plays. Therefore, a user behavior in a specific APP may only describe user's interest in a limited scenario, and it is difficult to cover all user's interest. For example, in the video APP, the user is often recommended with video content such as TV plays that the user may like, and original novels of TV plays may not be recommended to the user. However, the user may also be interested in the original novels when the user is interested in the TV plays. As a result, in the conventional recommendation method, it is difficult to cover all user's interest.

In addition, the amount of user behavior data in different product domains greatly differs due to a great difference between quantities of daily active users in different product domains, for example, an order of user behavior data in a product domain A is more than 100 times that in a product domain B (for example, a reading APP). When a multi-target model is trained by using different amounts of user behavior data together, user behavior data with a small amount may be drowned in mass other user behavior data. As a result, effective model training cannot be performed, the information recommendation effect is poor even if in consideration of cross-domain recommendation, and especially for a product with a small data volume, the recommendation effect cannot meet user requirements.

In view of this, an embodiment of this application provides an artificial intelligence-based method for training an information recommendation model. In such a method, a generative adversarial network is applied to cross-product domain recommendation, thereby achieving the effect of cross-product domain recommendation. A generative model generates more sample data to balance sample proportions in different product domains, thereby improving the training effect of a discriminative model and the recommendation effect of a small sample product domain. A fairly good output may be generated through mutual game learning between the discriminative model and the generative model, so that the generative model has higher prediction accuracy, and a generated pseudo sample has a better effect, thereby further improving the recommendation effect during information recommendation.

The method provided in this embodiment of this application relates to the field of cloud technologies, for example, big data. The big data refers to a collection of data that cannot be captured, managed and processed by conventional software tools within a certain time range. The big data is a massive, highly-growing and diversified information asset that requires new processing modes to have stronger decision-making, insight and process optimization capabilities. With the advent of a cloud era, the big data also attracts more and more attention, and the big data requires special techniques to efficiently process a large amount of data that tolerates elapsed time. Technologies applicable to the big data, include a massively parallel processing database, data mining, a distributed file system, a distributed database, a cloud computing platform, an Internet, and a scalable storage system. For example, mining historical user behavior data of the user in various product domains.

The method provided in this embodiment of this application further relates to the field of artificial intelligence. Artificial Intelligence (AI) is a theory, method, technology, and application system that uses a digital computer or a machine controlled by the digital computer to simulate, extend, and expand human intelligence, perceive an environment, acquire knowledge, and use knowledge to obtain an optimal result.

The artificial intelligence technology is a comprehensive discipline, and relates to a wide range of fields including both hardware-level technologies and software-level technologies. Artificial intelligence software technologies mainly include several major directions such as a computer vision technology, a speech processing technology, a natural language processing technology, and machine learning/deep learning.

In this embodiments of this application, the involved artificial intelligence technologies include directions such as natural language processing, deep learning, and the like. Natural language processing (NLP) is an important direction in the field of computer technologies and the artificial intelligence. It studies various theories and methods that enable effective communication between humans and computers in natural language. Natural language processing is a science that integrates linguistics, computer science and mathematics. Therefore, research in this field involves natural language, that is, a language that people use daily, so it is closely related to the study of linguistics. The natural language processing technology generally includes technologies such as text processing, semantic understanding, machine translation, robot question and answer, and knowledge graph.

Machine learning is a multi-field interdiscipline and relates to a plurality of disciplines such as the probability theory, statistics, the approximation theory, convex analysis, and the algorithm complexity theory. Machine learning specializes in studying how a computer simulates or implements a human learning behavior to obtain new knowledge or skills, and reorganize an existing knowledge structure, so as to keep improving performance of the computer. The machine learning is a core of the artificial intelligence, is a basic way to make the computer intelligent, and is applicable to various fields of artificial intelligence. Machine learning usually includes the technology such as deep learning. Deep learning includes artificial neural network, such as a convolutional neural network (CNN), a recurrent neural network (RNN), or a deep neural network (DNN).

In this embodiment, a generative adversarial network (GAN) may be trained through machine learning. The generative adversarial network includes a generative model and a discriminative model. Since user click sample data may reflect user's interest and hobbies, a trained discriminative model may identify such data, that is, the user's interest may be identified. Therefore, the trained discriminative model may be used as an information recommendation model to recommend information to the user online. The generative model generates more sample data to balance sample proportions in different product domains, to improve the training effect of the discriminative model, and in turn, the discriminative model may further improve the training effect of the generative model. The generative model and the discriminative model mutually improve in an adversarial manner, thereby further improving the effect of cross-product domain recommendation.

The method provided in this embodiment of this application is applicable to various recommendation systems to achieve cross-product domain information recommendation. For example, the user may browse articles and videos included in an official account platform and a video platform recommended by a recommendation system in interfaces of a “Top Stories” mini program and a “reading” mini program of a specific product. The recommendation system recommends content according to features such as user's age and gender, an article category and keywords, and historical user behavior data, to achieve “adaptability and diversity” of personalized information recommendation.

For ease of understanding the technical solutions of this application, the artificial intelligence-based method for training an information recommendation model provided in this embodiment of this application is described below with reference to a practical application scenario.

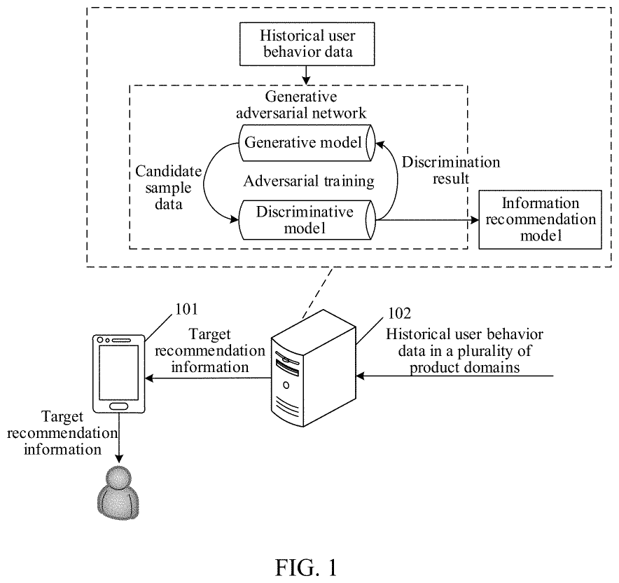

Referring to FIG. 1, FIG. 1 is a schematic diagram of an application scenario of a method for training an information recommendation model according to an embodiment of this application. The application scenario includes a terminal device 101 and a server 102. One or more products, such as a reading APP, may be installed on the terminal device 101. When the terminal device 101 opens the reading APP, the server 102 may return target recommendation information to the terminal device 101 through a recommendation system, to recommend content to the user across domains. For example, in the reading APP, books such as novels may be recommended to the user, and TV plays adapted from novels may also be recommended to the user.

The server 102 may be an independent physical server, or may be a server cluster including a plurality of physical servers or a distributed system, or may be a cloud server providing a cloud computing service. The terminal device 101 may be a smartphone, a tablet computer, a notebook computer, a desktop computer, a smart speaker, a smartwatch, or the like, but is not limited thereto. The terminal device 101 and the server 102 may be directly or indirectly connected in a wired or wireless communication manner. This is not limited in this application.

To achieve cross-domain recommendation, the server 102 may obtain historical user behavior data in a plurality of product domains, to achieve user behavior supplement between different product domains, thereby further training an information recommendation model. The historical user behavior data may reflect users' content click in various product domains, to further reflect user's interest and hobbies.

In this application, a generative adversarial network is applied to a scenario of cross-product domain recommendation. Since the user is less likely to simultaneously use a plurality of products, user behavior features in a multi-product domain are sparse, the amount of historical user behavior data is insufficient, and especially for a product domain with less historical user behavior data, it is difficult to train and obtain an effective recommendation model. Therefore, the server 102 may generate a pseudo sample by using a generative model in the generative adversarial network to increase the amount of the user behavior data.

By using each to-be-expanded product domain in the plurality of product domains as a target product domain, the server 102 generates candidate sample data of the target product domain according to the historical user behavior data by using the generative model. The server 102 performs discrimination on the candidate sample data of the target product domain and acquired user click sample data by using a discriminative model in the generative adversarial network, to obtain a discrimination result. The discrimination result may reflect a recognition capability of the discriminative model, and may further reflect a confidence degree of the pseudo sample generated by the generative model. Therefore, the server 102 may perform adversarial training on the generative model and the discriminative model according to the discrimination result, to mutually improve in an adversarial manner, to obtain a trained generative adversarial network.

The method for training an information recommendation model provided in this embodiment of this application is described below with reference to the accompanying drawings by using the server as an execution body.

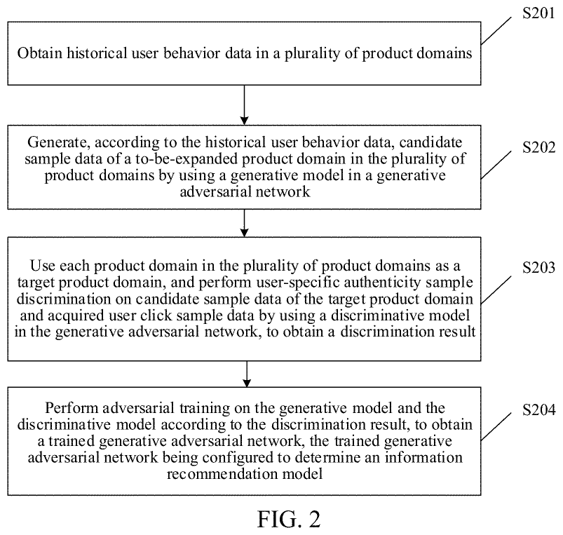

Referring to FIG. 2, FIG. 2 is a flowchart of a method for training an information recommendation model. The method includes:

S201: Obtain historical user behavior data in a plurality of product domains.

The server may obtain the historical user behavior data in the plurality of product domains. The historical user behavior data may be represented in a plurality of manners. In a possible implementation, the historical user behavior data may be represented by a triplet relationship data structure. The triplet relationship data structure represents a correspondence between a product domain, a user, and user clicked content, which may be represented as (User, Domain, Item), where User represents a user, Domain represents a product domain, and Item represents user clicked content in a corresponding Domain.

The historical user behavior data of the cross-product domain may be formally defined through the triplet relationship data structure, to facilitate subsequent training of the generative adversarial network.

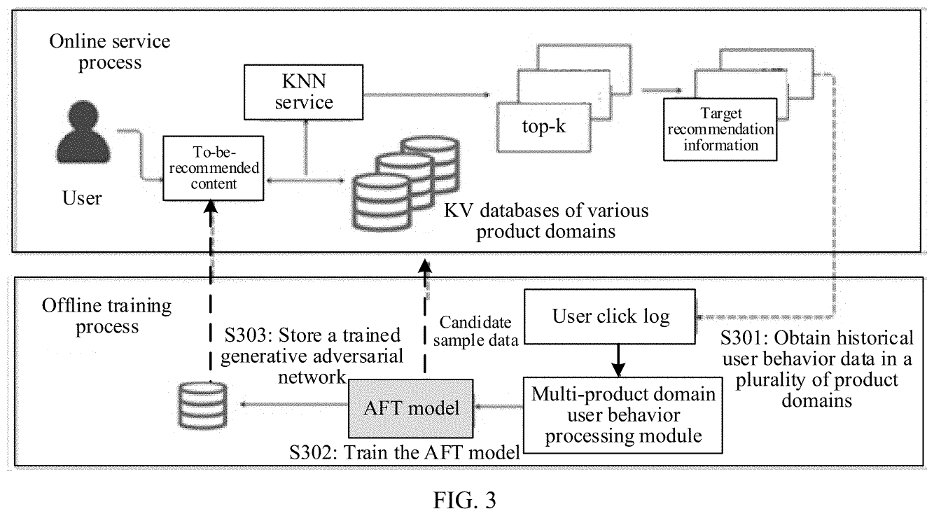

Referring to FIG. 3, FIG. 3 is an overall framework diagram of an information recommendation method, mainly including an offline training process and an online service process. The offline training process refers to a process of training the generative adversarial network offline, and the online service process refers to a process in which when the user uses a specific product or APP, information is recommended to the user by using the trained discriminative model.

During the offline training, the server may obtain historical user behavior data of a plurality of product domains from a user click log by using a multi-product domain user behavior processing module (which refers to S301 in FIG. 3).

When the historical user behavior data is obtained, the multi-product domain user behavior processing module summarizes online user behavior data of the user in various product domains, and then constructs a three-dimensional candidate set (domain, items, label), where Domain represents a product domain, Item represents user clicked content in a corresponding Domain, and label includes two behaviors, namely, exposure clicking and exposure non-clicking, which are used as labels to train a generative model configured to generate a pseudo sample.

In some cases, there may be some useless data in the obtained historical user behavior data, which is difficult to reflect the user's interest. For example, the user clicks all browsed content one by one, and as a result, it is difficult to analyze the user's interest. Therefore, in some possible implementations, data processing operations such as data cleaning and extreme behavior filtering may be performed on the online user behavior data in the plurality of product domains, to obtain the historical user behavior data.

S202: Generate, according to the historical user behavior data, candidate sample data of one or more target product domains including a to-be-expanded product domain in the plurality of product domains by using a generative model in a generative adversarial network.

The obtained historical user behavior data in the plurality of product domains may be used for training a cross-product domain information recommendation model. However, since the user is less likely to simultaneously use a plurality of products, user behavior features in a multi-product domain are sparse, the amount of historical user behavior data is insufficient, and especially for a product domain with less historical user behavior data, it is difficult to train and obtain an effective information recommendation model. Therefore, the generative model may be used to generate the pseudo sample, that is, the candidate sample data, to expand the data volume of the small sample product domain and balance the sample proportions in different product domains.

In this embodiment, the historical user behavior data in the plurality of product domains all may be expanded, that is, the to-be-expanded product domain is the plurality of product domains, so that the recommendation effects of both a product domain with a small data volume and a product domain with a large data volume may be improved.

However, for some product domains with a large data volume, since the data volume of the product domain is already very large and comprehensive, and even if the user behavior data is expanded, the recommendation effect is difficult to be improved or the recommendation effect is not obviously improved. In this case, to reduce the amount of calculation, the user behavior data may be expanded by generating the pseudo sample only for the product domain with the small data volume. In this case, the to-be-expanded product domain is the product domain with the small data volume in the plurality of product domains, for example, may be a product domain whose amount of the historical user behavior data is less than a preset threshold in the plurality of product domains.

In this embodiment, the used generative adversarial network may be an adversarial feature translation for multi-task recommendation (AFT) model, and certainly may be another generative adversarial network. This is not limited in this embodiment of this application. The description is made below mainly by using an example in which the generative adversarial network is an AFT model.

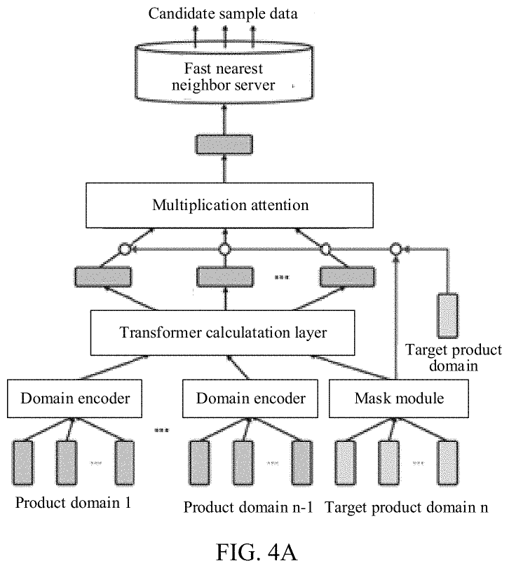

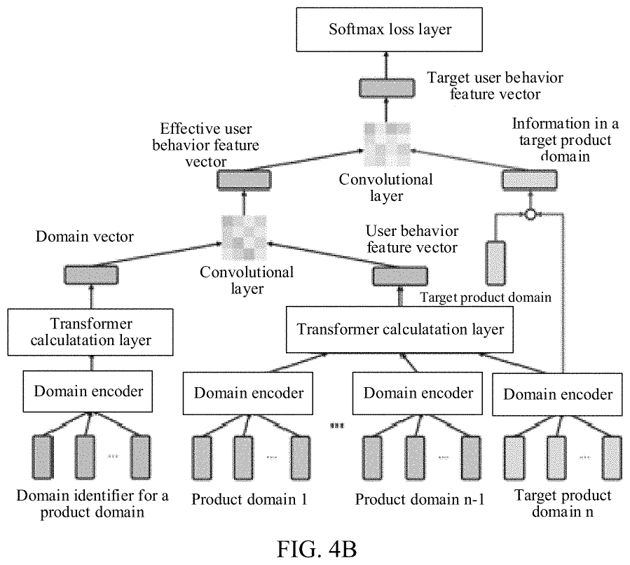

In some cases, model structures of a generative model and a discriminative model included in the AFT model may respectively refer to FIG. 4A and FIG. 4B. The generative model may include a domain encoder, a mask module, a transformer calculation layer, and a fast nearest neighbor server corresponding to each product domain. In FIG. 4A, a product domain 1, . . . , and a product domain N respectively correspond to one domain encoder, historical user behavior data in each product domain is encoded by a corresponding domain encoder to obtain an encoded user behavior feature vector, where the encoded user behavior feature vector may be a user behavior feature vector most relevant to the product domain.

After historical user behavior data in a target product domain is processed by the mask module, transformer calculation is performed on the historical user behavior data and the encoded user behavior feature vector, to obtain a plurality of groups of influence weights of an encoded user behavior feature vector in each product domain on the target product domain, that is, multi-head vectors are retained, multi-product domain information of the user is retained as completely as possible, and loss of information transmission is reduced while effective information of the user behavior feature vector in a cross-product domain is enlarged. Multiplication attention is performed on the influence weight and the encoded user behavior feature vector in the target product domain, the most relevant expression in user cross-domain feature information with the target product domain is extracted, and irrelevant information is filtered, which is abstracted as a target user behavior vector of the user in the target product domain. Then, candidate sample data in each product domain is generated according to the target user behavior vector. The candidate sample data in each product domain may be first k sample data selected, by using a k-Nearest Neighbor (KNN) algorithm, from sample data generated by the generative model.

S203: Use each product domain in the plurality of product domains as a target product domain, and perform user-specific authenticity sample discrimination on candidate sample data of the target product domain and acquired user click sample data by using a discriminative model in the generative adversarial network, to obtain a discrimination result.

After candidate sample data is generated by the generative model, the discriminative model may perform discrimination on the generated candidate sample data and the acquired user click sample data, to obtain the discrimination result. The discrimination result may include a first discriminant score of the discriminative model for candidate sample data of one user and a second discriminant score for user click sample data of the user. Since the candidate sample data is a pseudo sample generated by the generative model and the user click sample data is an acquired real sample, a training expectation for the discriminative model is that: the first discriminant score is as low as possible, and the second discriminant score is as high as possible, to better distinguish between real and pseudo samples.

The model structure of the discriminative model may refer to FIG. 4B, the discriminative model includes a domain encoder, a transformer calculation layer, a convolutional layer, and a softmax loss layer. The historical user behavior data in the each product domain is processed by a corresponding domain encoder and transformer calculation layer, to obtain a user behavior feature vector. A domain identifier for a product domain, for example, an identity (ID) is processed by the domain encoder and the transformer calculation layer, to obtain a domain vector. The domain vector and the user behavior feature vector are processed by the convolutional layer to obtain an effective user feature vector, the effective user feature vector and information in the target product domain are processed by the convolutional layer to obtain a target user behavior feature vector of the user in a target domain, and then prediction is performed through the softmax loss layer, to obtain a prediction result (for example, a discrimination result) and a corresponding loss function.

In some cases, the discrimination result includes a first discriminant score and a second discriminant score, and the generative model and the discriminative model further include fully-connected layers. The fully-connected layer included in the generative model may be referred to as a first fully-connected layer, and the fully-connected layer included in the discriminative model may be referred to as a second fully-connected layer. In this case, an implementation of S203 may include: inputting the candidate sample data outputted by the first fully-connected layer of the generative model into the second fully-connected layer of the discriminative model, and performing discrimination on the candidate sample data through the second fully-connected layer, to obtain the first discriminant score; and inputting the user click sample data into the second fully-connected layer, and performing discrimination on the user click sample data through the second fully-connected layer, to obtain the second discriminant score.

S204: Perform adversarial training on the generative model and the discriminative model according to the discrimination result, to obtain a trained generative adversarial network.

The generative model in the generative adversarial network generates the pseudo sample, and a training expectation for the generative model is that: it is difficult for the discriminative model to distinguish between real and pseudo samples; and the discriminative model needs to distinguish between the real and pseudo samples as much as possible, and adversarial balance between the generative model and the discriminative model may be achieved by performing adversarial training, thereby improving the effect of two models. The generative adversarial network may be configured to determine an information recommendation model.

The generative model and the discriminative model have respective loss function calculations, which may be combined by a loss calculation formula of the AFT model to perform joint model training, and specific parameters of the two models are optimized, to improve the effect of each model. Finally, a balanced case in which the discriminative model has difficulty in distinguishing between samples generated by the generative model, and the samples generated by the generative model may be taken as real samples is achieved.

In this embodiment, a manner of performing adversarial training on the generative adversarial network may be alternate training performed on the generative model and the discriminative model. During the alternate training, when the discriminative model is trained, a network parameter of the generative model is fixed, and a network parameter of the discriminative model is trained by using a target loss function; when the generative model is trained, the network parameter of the discriminative model is fixed, and the network parameter of the generative model is trained by using the target loss function, to obtain a trained generative model; and the foregoing two training operations are alternately performed when a training end condition is not met. The training end condition may be that the target loss function converges, for example, the target loss function reaches a minimum value, or times of training reach a preset quantity. The trained discriminative model and the trained generative model are obtained by performing alternate training.

The loss function calculations respectively included in the generative model and the discriminative model may be obtained based on the discrimination result. Therefore, a possible implementation of S204 may include: constructing a first loss function of the generative model and a second loss function of the discriminative model according to the discrimination result, and then constructing the target loss function according to the first loss function and the second loss function. Since the AFT model has a corresponding Loss calculation formula, the target loss function may be constructed according to the Loss calculation formula of the AFT model by using the first loss function and the second loss function. Then, adversarial training is performed according to the target loss function until the target loss function is minimized, and the trained generative adversarial network is obtained.

The generative adversarial network provided in this embodiment of this application may be obtained by training the historical user behavior data (which refers to S302 in FIG. 3). In a possible implementation, in an application scenario of information recommendation, discrete user behavior data is used, but a discrete value is a limited candidate space. As a result, it is difficult to represent user behavior data through continuous vectors, and it is necessary to generate possible sample data for representation. Therefore, it is possible to generate sample data the same as that of a real sample when training of the generative model is convergent. A sample distribution loss function is introduced into the target loss function, to avoid generating such invalid sample data and ensure a difference between a pseudo sample generated by the generative model and a real sample. The sample distribution loss function is constructed according to first distribution of the user click sample data and second distribution of the candidate sample data, and a smaller value of the sample distribution loss function indicates a larger discrepancy between the first distribution and the second distribution. A training expectation is that the distribution discrepancy is as large as possible. Then, the target loss function is constructed according to the first loss function, the second loss function, and the sample distribution loss function.

The target loss function may be shown as formula (1):

L=λ_{D}L_{D}+λ_{G}L_{G}+λ_{S}L_{S}. (1)

L represents a target loss function, L_{G} represents a first loss function, L_{D} represents a second loss function, and L_{S} represents a sample distribution loss function. λ_{D}, λ_{G}, and λ_{S} are hyperparameters and may be set according to actual requirements. Generally, λ_{D}, λ_{G}, and λ_{S} may respectively be set to 0.2, 1.0, and 0.2.

In this embodiment, by introducing the sample distribution loss function, the AFT model controls the pseudo sample generated by the generative model not to be completely consistent with the real sample, to increase the amount of information and achieve a better effect of training the combined model.

In some cases, when the discrimination result is the first discriminant score of the discriminative model for the candidate sample data and the second discriminant score for the user click sample data, the manner of constructing the first loss function and the second loss function may include: obtaining a confidence score of the generative model for the candidate sample data; constructing the first loss function according to the first discriminant score and the confidence score; and constructing the second loss function according to the first discriminant score and the second discriminant score.

Based on the foregoing construction manner, a calculation formula of LD may be shown as formula (2):

$${L}_{D} = - \frac{1}{N} ( {\sum }_{{S}_{c}} log {p}_{d} ( {e}_{i} \vert u ) + {\sum }_{{S}_{g}} log ( 1 - {p}_{d} ( {e}_{i} \vert u ) ) ) \qquad ( 2 )$$

p_{d}(eᵢ|u) represents a discriminant score of the discriminative model for user behavior data. eᵢ under a user feature u; s_{c} is acquired user click sample data (that is, a real sample), that is to say, a summation operation on a left side of “+” is a summation operation performed on a processed second discriminant score; and. s_{g} is candidate sample data (that is, a pseudo sample) generated by the generative model, that is to say, a summation operation on a right side of “+” is a summation operation performed on a processed first discriminant score.

The discriminative model of the AFT model expects that a discriminant score (that is, the second discriminant score) for the real sample is as high as possible, and a discriminant score (that is, the first discriminant score) for the pseudo sample generated by the generative model is as low as possible. Since a learning method is to minimize an expectation, a minus is added in front of the formula, and a sum of all sample losses is averaged.

A calculation formula of L_{G} may be shown as formula (3):

$${L}_{G} = - {\sum }_{{S}_{g}} {p}_{g} ( {e}_{i} \vert u ) Q ( {e}_{i} , u ) , \\ Q ( {e}_{i} , u ) = {p}_{d} ( {e}_{i} \vert u ) \qquad ( 3 )$$

Different from a conventional calculation formula of GAN, the calculation formula of L_{G} is improved for discrete candidate sample data of the recommendation system. p_{g}(eᵢ|u) represents a confidence score of the generative model for generated candidate sample data. eᵢ under the user feature u. Q(eᵢ, u) represents a first discriminant score of the discriminative model for the candidate sample data under the user feature u, which indicates whether the discriminative model can correctly identify the pseudo sample generated by the generative model, to further combine the discriminative model with the generative model. The generative model expects that the first discriminant score of the discriminative model for the candidate sample data is as high as possible, which is equivalent to deceiving the discriminative model. Since a learning method is to minimize an expectation, a minus is added in front of the formula, and a summation operation is performed on the sum of all sample losses.

Based on the foregoing calculation formulas of L_{D} and L_{G}, it can be seen that both the discriminative model and the generative model may perform confidence calculation on the discrete candidate sample data. eᵢ. In addition, the discriminative model of the AFT model expects that a discriminant score (that is, the second discriminant score) for the real sample is as high as possible, and a discriminant score (that is, the first discriminant score) for the candidate sample data generated by the generative model is as low as possible, to distinguish between the real and pseudo samples. The generative model expects that the first discriminant score of the discriminative model for the candidate sample data is as high as possible, which deceives the discriminative model. Therefore, respective Loss calculations of the generative model and the discriminative model may be combined by a loss calculation formula of the AFT model to perform joint model training, and specific parameters of the two models are optimized, to improve the effect of each model.

The sample distribution loss function represents a distribution discrepancy between the first distribution and the second distribution, and the distribution discrepancy may be represented by a distance between the first distribution and the second distribution. The distance may be calculated in a plurality of manners, for example, Euclidean distance calculation, relative entropy calculation (which is also referred to as KL divergence calculation), or a maximum mean discrepancy (MMD) calculation. Therefore, in some possible embodiments, a Euclidean distance, relative entropy, or a maximum mean discrepancy between the first distribution and the second distribution may be calculated, to construct the sample distribution loss function.

A calculation formula of Ls may be shown as formula (4):

$${L}_{S} = - {\sum }_{( {e}_{j} , u ) ∈ {S}_{g}} {\sum }_{( {e}_{k} , u ) ∈ {S}_{k}} {‖ {e}_{j} - {e}_{k} ‖}^{2} \qquad ( 4 )$$

eⱼ represents first distribution, and eₖ represents second distribution. L_{S} represents a distribution discrepancy between the real sample and the pseudo sample, and it is expected that the distribution discrepancy is as large as possible. Since a learning method is to minimize an expectation, a minus is added in front of the formula, and a summation operation is performed.

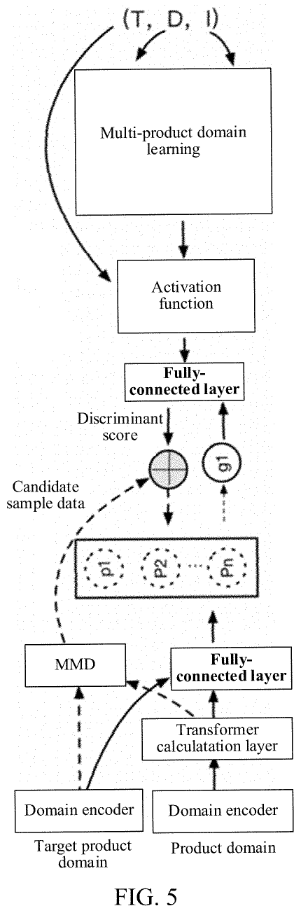

Based on the above, the structure of a combined model of the AFT model may refer to FIG. 5, historical user behavior data in a plurality of product domains is processed by a domain encoder, a transformer calculation layer, and a fully-connected layer (FC) of the generative model, and the historical user behavior data is combined with a user feature vector in a target product domain to obtain candidate sample data P1, P2, . . . , and Pn. The MMD is calculated with reference to the user click sample data in the target product domain, to facilitate the construction of the target loss function. The discriminative model performs multi-product domain learning according to the candidate sample data P1, P2, . . . , and Pn generated by the generative model, and user click sample data (which is denoted by T) in the target product domain and historical user behavior data (which is denoted by I) in a multi-product domain (which is denoted by D) that are inputted, the first discriminant score and the second discriminant score are obtained by discriminant scoring after activation function and the FC, to construct the target loss function with reference to the MMD, thereby performing adversarial training on the generative model and the discriminative model.

Based on the foregoing training process, a trained generative adversarial network may be obtained, and the trained generative adversarial network is stored (which refers to S303 in FIG. 3), for example, in a database, so that a discriminative model of the trained generative adversarial network may be provided for an online cross-product domain recommendation system to achieve cross-product domain recommendation. During the training, a vector form of the candidate sample data may be generated. Therefore, a vector of the candidate sample data may be stored in a database of each product, to be used for information recommendation during the online service process, as shown in FIG. 3. The database of the each product may be a Key-Value (KV) database.

It can be seen from the foregoing technical solutions that, during training, historical user behavior data in a plurality of product domains may be obtained. Since a user is less likely to simultaneously use a plurality of products, and consequently, user behavior features in a multi-product domain are sparse, the amount of user behavior data in the plurality of product domains is insufficient, and especially for a product domain with less user behavior data, it is difficult to train and obtain an effective information recommendation model. Therefore, candidate sample data of each product domain in a to-be-expanded product domain in the plurality of product domains is generated according to the historical user behavior data by using a generative model in a generative adversarial network, to generate a pseudo sample to increase the amount of the user behavior data. Each product domain in the plurality of product domains is used as a target product domain, discrimination is performed on candidate sample data of the target product domain and acquired user click sample data by using a discriminative model in the generative adversarial network to obtain a discrimination result, and adversarial training is further performed on the generative model and the discriminative model according to the discrimination result, to obtain a trained generative adversarial network. The trained generative adversarial network may be configured to determine an information recommendation model. According to the method, the generative adversarial network is introduced into cross-product domain information recommendation, and adversarial training is performed on the discriminative model and the generative model in the generative adversarial network according to user behavior data in the plurality of product domains. A fairly good output is generated through mutual game learning between the discriminative model and the generative model, so that the generative model has higher prediction accuracy, and a generated pseudo sample has a better effect, thereby further improving the recommendation effect during information recommendation.

In addition, the clod start effect in some product domains may be improved by using the method provided in this embodiment of this application.

The historical user behavior data and the user click sample data may reflect user's interest and hobbies, the trained discriminative model may identify such data, that is, the user's interest and hobbies, so that a discriminative model in a trained generative adversarial network may provide the discriminative model in the trained generative adversarial network to an online recommendation service, and during the online recommendation service, the discriminative model is used as an information recommendation model in the target product domain to recommend information to the user. The discriminative model in the trained generative adversarial network may be used as the information recommendation model in the target product domain and is provided for an online cross-product domain recommendation system, to achieve cross-product domain recommendation. When a user such as a target user browses content through a product, a recommendation request may be triggered, the server may obtain the recommendation request of the target user and determine candidate sample data corresponding to the target user according to the recommendation request. The candidate sample data may be generated based on the trained generative model, or may be obtained by performing S202. Then, to-be-recommended content (as shown in FIG. 3) is determined according to the candidate sample data corresponding to the target user by using an information recommendation model of the target product domain, and then target recommendation information is returned according to the to-be-recommended content.

In some possible implementations, the to-be-recommended content may be directly used as the target recommendation information to be returned to the terminal device and recommended to the target user.

In some cases, there may be excessive to-be-recommended content, making it difficult to recommend all the to-be-recommended content to the target user, or even if all the to-be-recommended content is recommended to the target user, it brings poor experience to the target user due to excessive to-be-recommended content. Therefore, in some other possible implementations, the manner of returning target recommendation information according to to-be-recommended content may include: sorting to-be-recommended content in descending order of a recommendation priority, determining a preset quantity of to-be-recommended content sorted top as target recommendation information, and returning the target recommendation information. The preset quantity may be represented by K, and the preset quantity sorted top may be represented as top-k.

In this embodiment, the to-be-recommended content may be sorted by using a k-Nearest Neighbor (KNN) classification algorithm, to determine the target recommendation information. For example, as shown in FIG. 3, through a KNN service, to-be-recommended content sorted top-k is determined as the target recommendation information and is recommended to the target user.

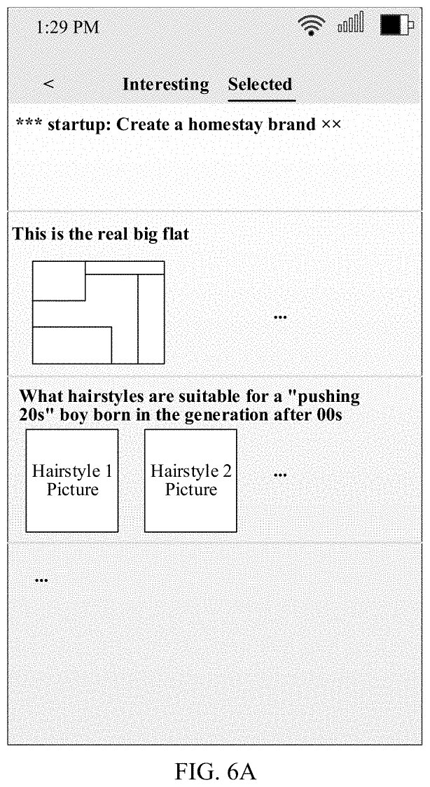

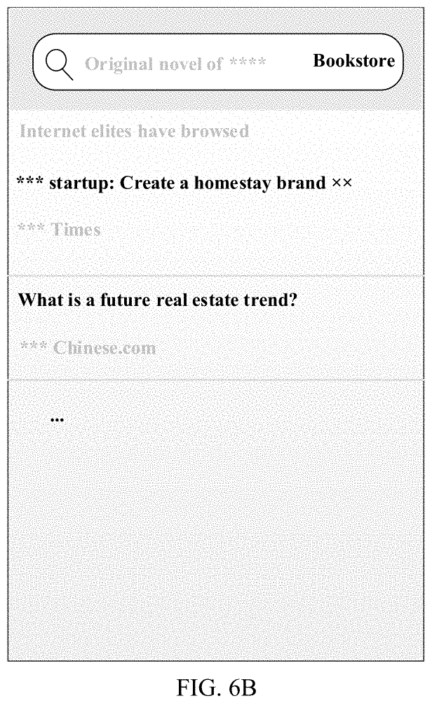

Using an example in which the target product domain is “Top Stories” or a reading APP of a specific APP, information recommendation is performed in the target product domain, recommendation interfaces may respectively refer to FIG. 6A and FIG. 6B, and information recommended to the user such as “*** startup: Create a homestay brand ××” is displayed on the recommendation interfaces. When the information recommendation model corresponding to the target product domain is obtained by performing training through S201 to S204, where the information recommendation model is trained based on historical user behavior data in a plurality of product domains (for example, an official account platform and a video platform), articles and videos included in the official account platform and the video platform may be browsed on “Top Stories” or the reading APP of the specific APP.

The terminal device may display the target recommendation information to the target user when the server returns target recommendation information to the terminal device. The target user may click on information the user is interested in in the target recommendation information for viewing, the terminal device may receive the click performed on the target recommendation information to generate click behavior data, and the server obtains the click behavior data of the target user for the target recommendation information from the terminal device, so that the multi-product domain user behavior processing module may collect the click behavior data, updates the historical user behavior data by using the click behavior data, and retrains the generative adversarial network according to the updated historical user behavior data, to update the generative adversarial network, to enable the generative adversarial network to adapt to change of user's interest, thereby further improving the recommendation effect of the discriminative model.

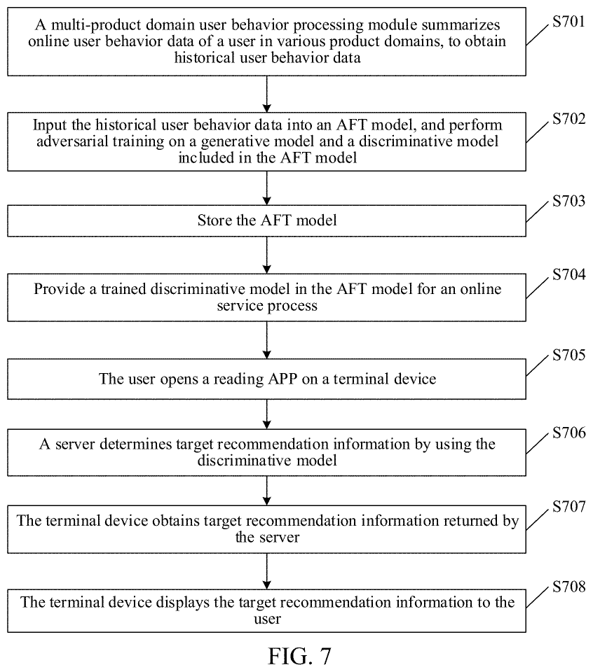

The training of the information recommendation model provided in this embodiment of this application is described below with reference to a practical application scenario. The application scenario may be that when the user browses a reading APP, the reading APP recommends information to the user according to user's age and gender, and historical user behavior data. To achieve cross-domain recommendation and meet user requirements, an embodiment of this application provides a cross-domain information recommendation method. Referring to FIG. 7, the method includes an offline training process and an online service process. The offline training process is mainly to train the generative adversarial network, and using an example in which the generative adversarial network is an AFT model, the online service process is mainly to recommend information to the user by using a discriminative model in the AFT model as an information recommendation model. The method includes:

S701: A multi-product domain user behavior processing module summarizes online user behavior data of a user in various product domains, to obtain historical user behavior data.

S702: Input the historical user behavior data into an AFT model, and perform adversarial training on a generative model and a discriminative model included in the AFT model.

S703: Store the AFT model.

S704: Provide a trained discriminative model in the AFT model for an online service process.

S705: The user opens a reading APP on a terminal device.

S706: A server determines target recommendation information by using the discriminative model.

S707: The terminal device obtains target recommendation information returned by the server.

S708: The terminal device displays the target recommendation information to the user.

S701 to S703 belong to the offline training process, and S704 to S708 belong to the online service process.

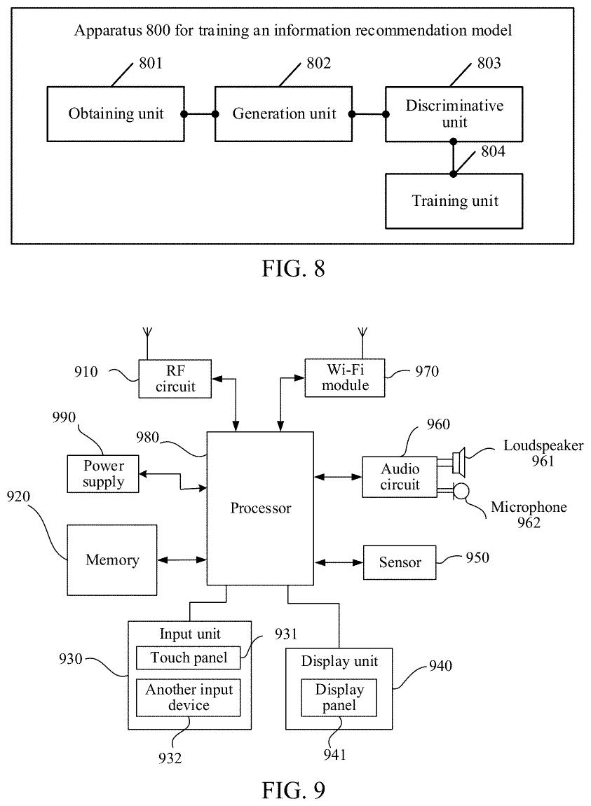

Based on the embodiment corresponding to FIG. 2, an embodiment of this application further provides an apparatus 800 for training an information recommendation model. Referring to FIG. 8, the apparatus 800 includes an obtaining unit 801, a generation unit 802, a discriminative unit 803, and a training unit 804, where

the obtaining unit 801 is configured to obtain historical user behavior data in a plurality of product domains;

the generation unit 802 is configured to generate, according to the historical user behavior data, candidate sample data of a to-be-expanded product domain in the plurality of product domains by using a generative model in a generative adversarial network;

the discriminative unit 803 is configured to use each product domain in the plurality of product domains as a target product domain, and perform user-specific authenticity sample discrimination on candidate sample data of the target product domain and acquired user click sample data by using a discriminative model in the generative adversarial network, to obtain a discrimination result; and

the training unit 804 is configured to perform adversarial training on the generative model and the discriminative model according to the discrimination result, to obtain a trained generative adversarial network, the trained generative adversarial network being configured to determine an information recommendation model.

In a possible implementation, the training unit 804 is configured to: perform alternate training on the generative model and the discriminative model, where a process of alternate training includes:

when the discriminative model is trained, fixing a network parameter of the generative model, and training a network parameter of the discriminative model by using a target loss function;

when the generative model is trained, fixing the network parameter of the discriminative model, and training the network parameter of the generative model by using the target loss function; and

alternately performing the foregoing two training operations when a training end condition is not met.

In a possible implementation, the training unit 804 is configured to:

construct a first loss function of the generative model and a second loss function of the discriminative model according to the discrimination result; and

construct the target loss function according to the first loss function and the second loss function.

In a possible implementation, the training unit 804 is configured to:

construct a sample distribution loss function according to first distribution of the user click sample data and second distribution of the candidate sample data, a smaller value of the sample distribution loss function indicating a larger discrepancy between the first distribution and the second distribution; and

construct the target loss function according to the first loss function, the second loss function, and the sample distribution loss function.

In a possible implementation, the training unit 804 is configured to:

calculate a Euclidean distance, relative entropy, or a maximum mean discrepancy between the first distribution and the second distribution, to construct the sample distribution loss function.

In a possible implementation, the discrimination result includes a first discriminant score and a second discriminant score, and the discriminative unit 803 is configured to:

input the candidate sample data outputted by a first fully-connected layer of the generative model into a second fully-connected layer of the discriminative model, and perform user-specific authenticity sample discrimination on the candidate sample data through the second fully-connected layer, to obtain the first discriminant score; and

input the user click sample data into the second fully-connected layer, and perform user-specific authenticity sample discrimination on the user click sample data through the second fully-connected layer, to obtain the second discriminant score.

In a possible implementation, the training unit 804 is further configured to:

obtain a confidence score of the generative model for the candidate sample data;

construct the first loss function according to the first discriminant score and the confidence score; and

construct the second loss function according to the first discriminant score and the second discriminant score.

In a possible implementation, the apparatus further includes a determining unit, where

the determining unit is configured to provide a discriminative model in the trained generative adversarial network for an online recommendation service; and

use the discriminative model as an information recommendation model of the target product domain during the online recommendation service.

In a possible implementation, the apparatus further includes a returning unit, where

the returning unit is configured to obtain a recommendation request from a target user; determine candidate sample data corresponding to the target user according to the recommendation request; determine, according to the candidate sample data corresponding to the target user, to-be-recommended content by using the information recommendation model of the target product domain; and

return target recommendation information according to the to-be-recommended content.

In a possible implementation, the returning unit is configured to:

sort the to-be-recommended content in descending order of a recommendation priority;

determine a preset quantity of to-be-recommended content sorted top as the target recommendation information; and

return the target recommendation information.

In a possible implementation, the obtaining unit 801 is further configured to:

obtain click behavior data of the target user for the target recommendation information;

the training unit 804 is further configured to:

update the historical user behavior data according to the click behavior data; and

retrain the trained generative adversarial network according to the updated historical user behavior data, to update the trained generative adversarial network.

In a possible implementation, the to-be-expanded product domain is a product domain whose amount of the historical user behavior data is less than a preset threshold in the plurality of product domains.

An embodiment of this application further provides a device for training an information recommendation model, and the device is configured to perform the method for training an information recommendation model provided in the embodiments of this application. The device is described below with reference to the accompanying drawings. Referring to FIG. 9, the device may be a terminal device, and the description is made below by using an example in which the terminal device is a smartphone:

FIG. 9 shows a block diagram of partial structure of a smartphone related to a terminal device according to an embodiment of this application. Referring to FIG. 9, the smartphone includes: components such as a radio frequency (Radio Frequency, RF for short) circuit 910, a memory 920, an input unit 930, a display unit 940, a sensor 950, an audio circuit 960, a wireless fidelity (WiFi for short) module 970, a processor 980, and a power supply 990. A person skilled in the art may understand that the structure of the smartphone shown in FIG. 9 does not constitute a limitation to the smartphone, and the smartphone may include more components or fewer components than those shown in the figure, or some components may be combined, or a different component deployment may be used.

The memory 920 may be configured to store a software program and a module. The processor 980 runs the software program and the module that are stored in the memory 920, to implement various functional applications and data processing of the smartphone. The memory 920 may mainly include a program storage area and a data storage area. The program storage area may store an operating system, an application program required by at least one function (for example, a sound playback function and an image display function), and the like. The data storage area may store data (for example, audio data and a phone book) created according to use of the smartphone. In addition, the memory 920 may include a high speed random access memory, and may also include a non-volatile memory, such as at least one magnetic disk storage device, a flash memory, or another volatile solid storage device.

The processor 990 is the control center of the smartphone, and is connected to various parts of the smartphone by using various interfaces and lines. By running or executing the software program and/or module stored in the memory 920, and invoking data stored in the memory 920, the processor performs various functions and data processing of the smartphone, thereby performing overall monitoring on the smartphone. In some embodiments, the processor 980 may include one or more processing units. Preferably, the processor 980 may integrate an application processor and a modem processor. The application processor mainly processes an operating system, a user interface, an application program, and the like. The modem processor mainly processes wireless communication. It may be understood that the foregoing modem may either not be integrated into the processor 980.

In this embodiment, the processor 980 in the terminal device (for example, the foregoing smartphone) may perform the following steps:

obtaining historical user behavior data in a plurality of product domains;

generating, according to the historical user behavior data, candidate sample data of each product domain of a to-be-expanded product domain in the plurality of product domains by using a generative model in a generative adversarial network;

using each product domain in the plurality of product domains as a target product domain, and performing discrimination on candidate sample data of the target product domain and acquired user click sample data by using a discriminative model in the generative adversarial network, to obtain a discrimination result; and

performing adversarial training on the generative model and the discriminative model according to the discrimination result, to obtain a trained generative adversarial network, the generative adversarial network being configured to determine an information recommendation model.

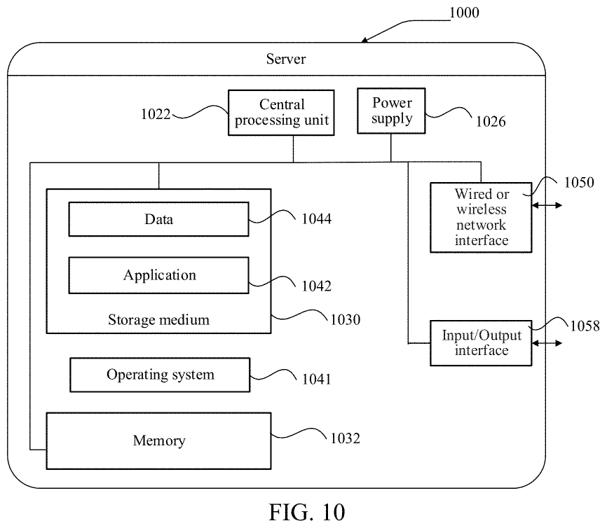

The device for training an information recommendation model provided in the embodiments of this application may be a server, referring to FIG. 10, FIG. 10 is a structural diagram of a server 1000 according to an embodiment of this application. The server 1000 may vary greatly due to different configurations or performance, and may include one or more central processing units (CPU) 1022 (for example, one or more processors) and a memory 1032, and one or more storage media 1030 (for example, one or more mass storage devices) that store an application program 1042 or data 1044. The memory 1032 and the storage mediums 1030 may be used for transient storage or permanent storage. A program stored in the storage medium 1030 may include one or more modules (which are not marked in the figure), and each module may include a series of instruction operations on the server. Still further, the central processing unit 1022 may be configured to communicate with the storage medium 1030 to perform the series of instruction operations in the storage medium 1030 on the server 1000.

The server 1000 may further include one or more power supplies 1026, one or more wired or wireless network interfaces 1050, one or more input/output interfaces 1058, and/or one or more operating systems 1041 such as Windows Server™, Mac OS X™, Unix™, Linux™, or FreeBSD™.

In this embodiment, the central processing unit 1022 in the server may perform the following steps:

obtaining historical user behavior data in a plurality of product domains;

generating, according to the historical user behavior data, candidate sample data of a to-be-expanded product domain in the plurality of product domains by using a generative model in a generative adversarial network;

using each product domain in the plurality of product domains as a target product domain, and performing user-specific authenticity sample discrimination on candidate sample data of the target product domain and acquired user click sample data by using a discriminative model in the generative adversarial network, to obtain a discrimination result; and

performing adversarial training on the generative model and the discriminative model according to the discrimination result, to obtain a trained generative adversarial network, the generative adversarial network being configured to determine an information recommendation model.

According to an aspect of this application, a computer-readable storage medium is provided. The computer-readable storage medium is configured to store program code, where the program code is used to perform the method for training an information recommendation model described in the foregoing embodiments.

According to an aspect of this application, a computer program product or computer program is provided. The computer program product or computer program includes computer instructions, the computer instructions being stored in a computer-readable storage medium. A processor of a computer device reads the computer instructions from the computer-readable storage medium, and executes the computer instructions, so that the computer device performs the method provided in the various implementations in the foregoing embodiments.

The terms such as “first”, “second”, “third”, and “fourth” (if any) in the specification and accompanying drawings of this application are used for distinguishing similar objects and not necessarily used for describing any particular order or sequence. Data used in this way is interchangeable in a suitable case, so that the embodiments of this application described herein can be implemented in a sequence in addition to the sequence shown or described herein. Moreover, the terms “include”, “contain”, and any other variants thereof mean to cover the non-exclusive inclusion. For example, a process, method, system, product, or device that includes a list of steps or units is not necessarily limited to those steps or units that are clearly listed, but may include other steps or units not expressly listed or inherent to such a process, method, system, product, or device.

In the several embodiments provided in this application, the disclosed system, apparatus, and method may be implemented in other manners. For example, the described apparatus embodiment is merely exemplary. For example, the unit division is merely a logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and the parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of this application may be integrated into one processing unit, or each of the units may exist alone physically, or two or more units may be integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or a part of the technical solutions may be implemented in the form of a software product. The computer software product is stored in a storage medium and includes several instructions for instructing a computer device (which may be a personal computer, a server or a network device) to perform all or some of the steps of the methods described in the embodiments of this application. The foregoing storage medium includes various media capable of storing program codes, such as, a USB flash drive, a mobile hard disk, a Read Only Memory (ROM), a Random Access Memory (RAM), a magnetic disk, or an optical disc.

The foregoing embodiments are merely intended for describing the technical solutions of this application, but not for limiting this application. Although this application is described in detail with reference to the foregoing embodiments, persons of ordinary skill in the art are to understand that they may still make modifications to the technical solutions described in the foregoing embodiments or make equivalent replacements to some technical features thereof, and such modifications or replacements may not cause the essence of corresponding technical solutions to depart from the spirit and scope of the technical solutions in the embodiments of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for training an information recommendation model performed by a computer device, comprising:
obtaining historical user behavior data in a plurality of product domains;
generating, according to the historical user behavior data, candidate sample data of one or more target product domains in the plurality of product domains by using a generative model in a generative adversarial network;
performing user-specific authenticity sample discrimination on the candidate sample data of each target product domain and acquired user click sample data by using a discriminative model in the generative adversarial network, to obtain a discrimination result; and
performing adversarial training on the generative model and the discriminative model according to the discrimination result, to obtain a trained generative adversarial network, the trained generative adversarial network being configured to determine an information recommendation model for a to-be-expanded product domain in the plurality of product domains.

2. The method according to claim 1, wherein the performing adversarial training on the generative model and the discriminative model according to the discrimination result, to obtain a trained generative adversarial network comprises:
performing alternate training on the generative model and the discriminative model, wherein a process of alternate training comprises:
when the discriminative model is trained, fixing a network parameter of the generative model, and training a network parameter of the discriminative model by using a target loss function;
when the generative model is trained, fixing the network parameter of the discriminative model, and training the network parameter of the generative model by using the target loss function; and
alternately performing the foregoing two training operations when a training end condition is not met.

3. The method according to claim 2, wherein a manner of constructing the target loss function comprises:
constructing a first loss function of the generative model and a second loss function of the discriminative model according to the discrimination result; and
constructing the target loss function according to the first loss function and the second loss function.

4. The method according to claim 3, wherein the constructing the target loss function according to the first loss function and the second loss function comprises:
constructing a sample distribution loss function according to first distribution of the user click sample data and second distribution of the candidate sample data, a smaller value of the sample distribution loss function indicating a larger discrepancy between the first distribution and the second distribution; and
constructing the target loss function according to the first loss function, the second loss function, and the sample distribution loss function.

5. The method according to claim 4, wherein the constructing a sample distribution loss function according to first distribution of the user click sample data and second distribution of the candidate sample data comprises:
calculating a Euclidean distance, relative entropy, or a maximum mean discrepancy between the first distribution and the second distribution, to construct the sample distribution loss function.

6. The method according to claim 3, wherein the discrimination result comprises a first discriminant score and a second discriminant score, and the performing user-specific authenticity sample discrimination on candidate sample data of the target product domain and acquired user click sample data by using a discriminative model in the generative adversarial network, to obtain a discrimination result comprises:
inputting the candidate sample data outputted by a first fully-connected layer of the generative model into a second fully-connected layer of the discriminative model, and performing user-specific authenticity sample discrimination on the candidate sample data through the second fully-connected layer, to obtain the first discriminant score; and
inputting the user click sample data into the second fully-connected layer, and performing user-specific authenticity sample discrimination on the user click sample data through the second fully-connected layer, to obtain the second discriminant score.

7. The method according to claim 6, wherein the constructing a first loss function of the generative model and a second loss function of the discriminative model according to the discrimination result comprises:
obtaining a confidence score of the generative model for the candidate sample data;
constructing the first loss function according to the first discriminant score and the confidence score; and
constructing the second loss function according to the first discriminant score and the second discriminant score.

8. The method according to claim 1, further comprising:
providing a discriminative model in the trained generative adversarial network for an online recommendation service; and
using the discriminative model as an information recommendation model of the to-be-expanded product domain during the online recommendation service.

9. The method according to claim 8, further comprising:
obtaining a recommendation request from a target user;
determining candidate sample data corresponding to the target user according to the recommendation request;
determining, according to the candidate sample data corresponding to the target user, to-be-recommended content by using the information recommendation model of the to-be-expanded product domain; and
returning target recommendation information to the target user according to the to-be-recommended content.

10. The method according to claim 9, wherein the returning target recommendation information to the target user according to the to-be-recommended content comprises:
sorting the to-be-recommended content in a descending order of a recommendation priority;
determining a preset quantity of to-be-recommended content sorted top as the target recommendation information; and
returning the target recommendation information to the target user.

11. The method according to claim 9, further comprising:
obtaining click behavior data of the target user for the target recommendation information;
updating the historical user behavior data according to the click behavior data; and
retraining the trained generative adversarial network according to the updated historical user behavior data, to update the trained generative adversarial network.

12. The method according to claim 1, wherein the to-be-expanded product domain is a product domain whose amount of the historical user behavior data is less than a preset threshold in the plurality of product domains.

13. A computer device, comprising a processor and a memory:
the memory being configured to store program code and transmit the program code to the processor; and
the processor being configured to perform a method for training an information recommendation model including:
obtaining historical user behavior data in a plurality of product domains;
generating, according to the historical user behavior data, candidate sample data of one or more target product domains in the plurality of product domains by using a generative model in a generative adversarial network;
performing user-specific authenticity sample discrimination on the candidate sample data of each target product domain and acquired user click sample data by using a discriminative model in the generative adversarial network, to obtain a discrimination result; and
performing adversarial training on the generative model and the discriminative model according to the discrimination result, to obtain a trained generative adversarial network, the trained generative adversarial network being configured to determine an information recommendation model for a to-be-expanded product domain in the plurality of product domains.

14. The computer device according to claim 13, wherein the performing adversarial training on the generative model and the discriminative model according to the discrimination result, to obtain a trained generative adversarial network comprises:
performing alternate training on the generative model and the discriminative model, wherein a process of alternate training comprises:
when the discriminative model is trained, fixing a network parameter of the generative model, and training a network parameter of the discriminative model by using a target loss function;
when the generative model is trained, fixing the network parameter of the discriminative model, and training the network parameter of the generative model by using the target loss function; and
alternately performing the foregoing two training operations when a training end condition is not met.

15. The computer device according to claim 13, wherein the method further comprises:
providing a discriminative model in the trained generative adversarial network for an online recommendation service; and
using the discriminative model as an information recommendation model of the to-be-expanded product domain during the online recommendation service.

16. The computer device according to claim 15, wherein the method further comprises:
obtaining a recommendation request from a target user;
determining candidate sample data corresponding to the target user according to the recommendation request;
determining, according to the candidate sample data corresponding to the target user, to-be-recommended content by using the information recommendation model of the to-be-expanded product domain; and
returning target recommendation information to the target user according to the to-be-recommended content.

17. The computer device according to claim 16, wherein the returning target recommendation information to the target user according to the to-be-recommended content comprises:
sorting the to-be-recommended content in a descending order of a recommendation priority;
determining a preset quantity of to-be-recommended content sorted top as the target recommendation information; and
returning the target recommendation information to the target user.

18. The computer device according to claim 16, wherein the method further comprises:
obtaining click behavior data of the target user for the target recommendation information;
updating the historical user behavior data according to the click behavior data; and
retraining the trained generative adversarial network according to the updated historical user behavior data, to update the trained generative adversarial network.

19. The computer device according to claim 13, wherein the to-be-expanded product domain is a product domain whose amount of the historical user behavior data is less than a preset threshold in the plurality of product domains.

20. A non-transitory computer-readable storage medium, configured to store program codes that, when executed by a processor of a computer device, cause the computer device to perform a method for training an information recommendation model including:
obtaining historical user behavior data in a plurality of product domains;
generating, according to the historical user behavior data, candidate sample data of one or more target product domains in the plurality of product domains by using a generative model in a generative adversarial network;
performing user-specific authenticity sample discrimination on the candidate sample data of each target product domain and acquired user click sample data by using a discriminative model in the generative adversarial network, to obtain a discrimination result; and
performing adversarial training on the generative model and the discriminative model according to the discrimination result, to obtain a trained generative adversarial network, the trained generative adversarial network being configured to determine an information recommendation model for a to-be-expanded product domain in the plurality of product domains.
